(19) United States
(12) Patent Application Publication
(10) Pub. No.: US 2009/0006726 A1
(43) Pub. Date: Jan. 1, 2009

(54) MULTIPLE ADAPTER FOR FLASH DRIVE AND ACCESS METHOD FOR SAME

(75) Inventors: PIN-FENG FU, Shenzhen (CN); SHIH-FANG WONG, Tu-Cheng (TW); LIN-LIN GUO, Shenzhen (CN); CHUN-HUA LI, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/960,719

(22) Filed: Dec. 20, 2007

(30) Foreign Application Priority Data
Jun. 28, 2007 (CN) 200710200914.2

(51) Int. Cl. G06F 12/02

(52) U.S. Cl. 711/103; 711/E12.008

(57) ABSTRACT

A multiple adapter is used for assembling a plurality of flash drives. The multiple adapter includes a multiple expansion port, a detector, a file manager, and a controller. The multiple expansion port coupled to the flash drives. The detector is coupled to the multiple expansion port for detecting store information of the flash drives. The file manager is coupled to the multiple expansion port and the detector for receiving the store information and calculating total memory capacity and total spare capacity of the flash drives. The controller is used for controlling the detector and the file manager. A writing procedure and a reading procedure of an access method are also provided.

### BACKGROUND

1. Field of the Invention

The present invention generally relates to removable memories, and more particularly to a multiple adapter for flash drives and an access method for reading data from or writing data to the flash drives through the multiple adapter.

2. Description of Related Art

Universal serial bus (USB) flash drives are very popular because of its low cost, low power consumption, and small size. A USB flash drive is a flash memory integrated with a USB connector. Referring to FIG. 9, a USB flash drive 3 is plugged into a computer 2 to load or upload data. The computer 2 includes a controller 21 and a female connector 23. The USB flash drive 3 includes a controller 31, a male connector 33, and a memory 35. The male connector 33 and the female connector 23 are configured together to establish a connection therebetween. In operation, the controller 31 detects the USB flash drive 3, and supplies power to the USB flash drive 3. The controller 31 allocates an address to the USB flash drive 3, and then the controller 31 sends store information, such as memory capacity, spare capacity, and stored data, of the memory 35 to the computer 2.

When the memory of the USB flash drive is full the user must swap or remove the USB flash drive and replace it with a USB drive with free memory. If the memory of this replacement USB drive is also full the user must swap this replacement USB drive and replace it with another USB drive with free memory. This process is inconvenient. Also, the replacement USB flash drive and the new USB flash drive cannot be incorporated together to be used at the same time.

Therefore, improvements for a multiple adapter for flash drives and an access method are needed in the industry to address the aforementioned deficiency.

### SUMMARY

A multiple adapter is used for assembling a plurality of flash drives. The multiple adapter includes a multiple expansion port, a detector, a file manager, and a controller. The multiple expansion port coupled to the flash drives. The detector is coupled to the multiple expansion port for detecting store information of the flash drives. The file manager is coupled to the multiple expansion port and the detector for receiving the store information and calculating total memory capacity and total spare capacity of the flash drives. The controller is used for controlling the detector and the file manager. A writing procedure and a reading procedure of an access method are also provided.

Other advantages and novel features of the present invention will become more apparent from the following detailed description of preferred embodiment when taken in conjunction with the accompanying drawings.

### BRIEF DESCRIPTION OF THE DRAWINGS

FIG. 1 is a schematic diagram showing a multiple adapter in accordance with an exemplary embodiment.

FIG. 2 is a schematic, block diagram showing the multiple adapter of FIG. 1.

FIG. 3 shows a file management table stored in the multiple adapter.

FIG. 4 shows a file information table stored in the multiple adapter.

FIG. 5 shows an updated file management table after a writing operation of the multiple adapter.

FIG. 6 shows an updated file information table after the writing operation of the multiple adapter.

FIG. 7 is a flow chart showing a writing procedure of an access method in accordance with an exemplary embodiment.

FIG. 8 is a flow chart showing a reading procedure of an access method in accordance with an exemplary embodiment.

FIG. 9 shows a conventional connection between a computer and a USB flash drive.

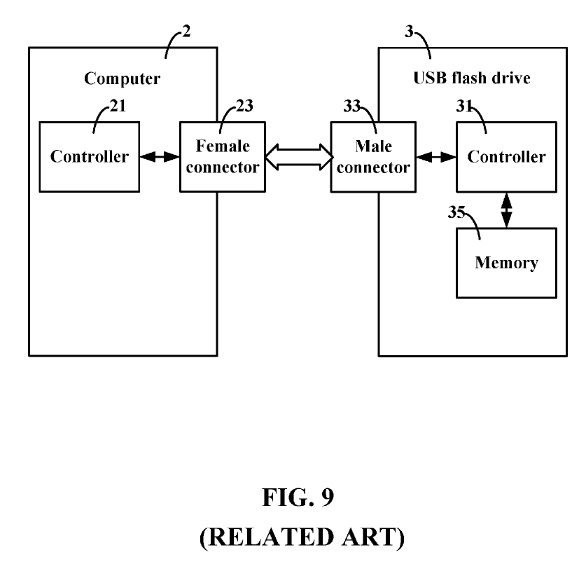

### DETAILED DESCRIPTION OF THE EMBODIMENTS

Reference will now be made to the drawings to describe a preferred embodiment of the present multiple adapter and a preferred embodiment of the present access method.

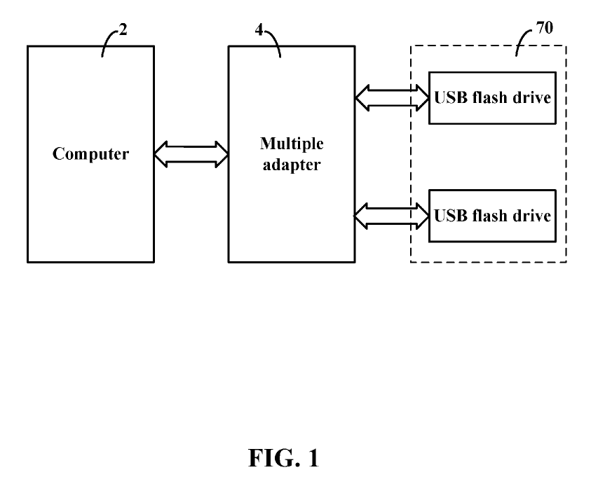

Referring to FIG. 1, a multiple adapter 4 in accordance with an exemplary embodiment is used for attaching a plurality of USB flash drives 70 and electrically connecting the plurality of USB flash drives 70 to a computer 2. In operation, the computer 2 supplies power to the multiple adapter 4 and the plurality of USB flash drives 70. The multiple adapter 4 generates a management table for identifying each of the plurality of USB flash drives 70.

When a write operation is being performed, the computer 2 sends a write command and the to-be-written data to the multiple adapter 4. The multiple adapter 4 receives the write command, and selects one of the plurality of USB flash drives 70 to store the to-be-written data according to the management table. When a read operation is being performed, the computer 2 sends a read command to the multiple adapter 4. The multiple adapter 4 receives the read command, and reads stored data from a destination drive of the USB flash drives 70 according to the management table, and sends the stored data to the computer 2.

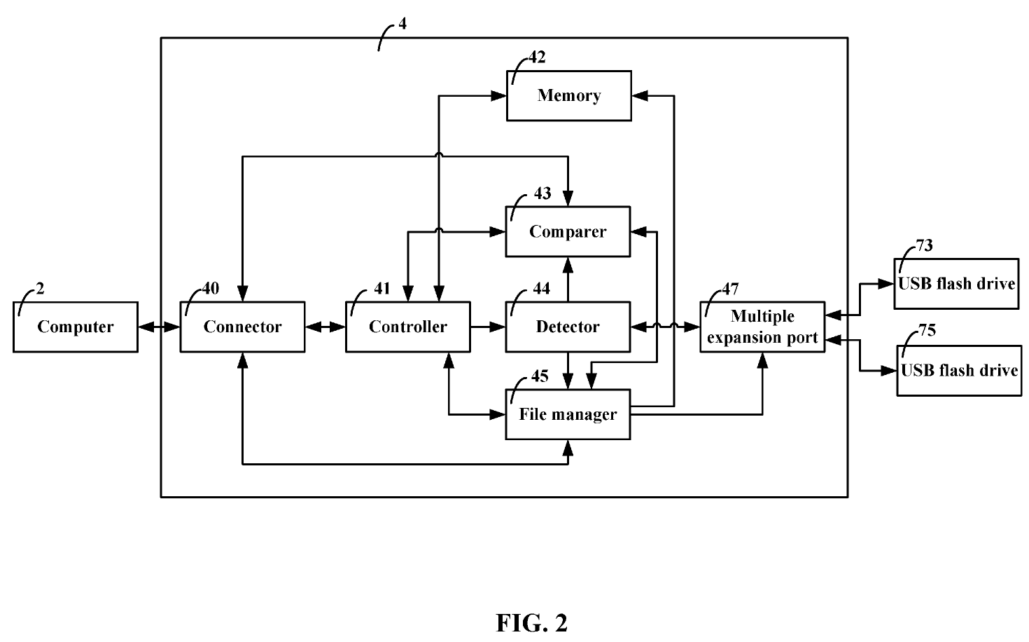

Referring to FIG. 2, the multiple adapter 4 includes a connector 40, a controller 41, a memory 42, a comparer 43, a detector 44, a file manager 45, and a multiple expansion port 47. The controller 41 is coupled to the connector 40, the controller 41, the memory 42, the comparer 43, the detector 44, and the file manager 45. The comparer 43 is coupled to the connector 40, the detector 44, and the file manager 45. The file manager 45 is coupled to the connector 40, the memory 42, the detector 44, and the multiple expansion port 47. The multiple expansion port 47 is coupled to the detector 44.

In the embodiment, a USB flash drive 73 and a USB flash drive 75 are coupled to the multiple expansion port 47 for exemplary purposes. When the multiple adapter 4 is coupled to the computer 2, the computer 2 supplies power to the multiple adapter 4 and the USB flash drives 73, 75. The controller 41 controls the detector 44 to detect store information of the plurality USB flash drives 73 and 75, and to send the store information to the file manager 45. The store information includes identifiers, memory capacities, spare capacities, logical addresses to spare capacities, file names, and logical addresses to files. The file manager 45 calculates total memory capacity, total spare capacity of the USB flash drives 73 and 75, and generates a file management table and a file information table. The memory 42 stores the total memory capacity, the total spare capacity, the file management table, and the file information table.

Before accessing the USB flash drives 73 and 75 through the multiple adapter 4, the computer 2 sends an access signal to the controller 41. The controller 41 controls the file manager 45 to generate the file management table and the file information table.

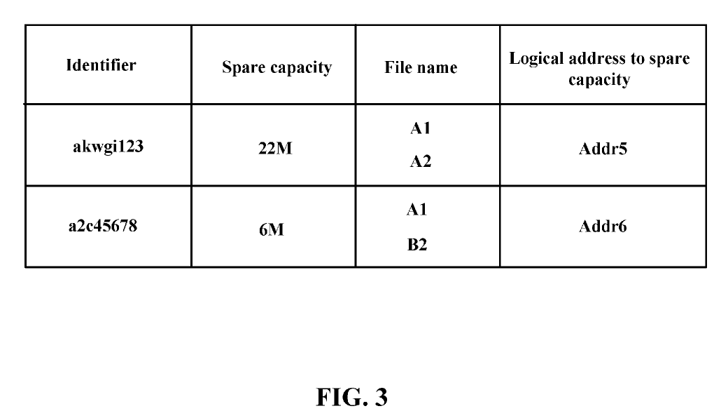

Referring to FIG. 3, the file management table records the identifiers, the spare capacities, the file names, and the logical addresses to the spare capacities. Regarding the USB flash drive 73, its identifier is akwgi123, spare capacity is 22 M, file names are A1 and A2, and logical address is Addr5. Regarding the USB flash drive 75, its identifier is a2c45678, spare capacity is 6 M, file names are A1 and B2, and logical address is Addr6.

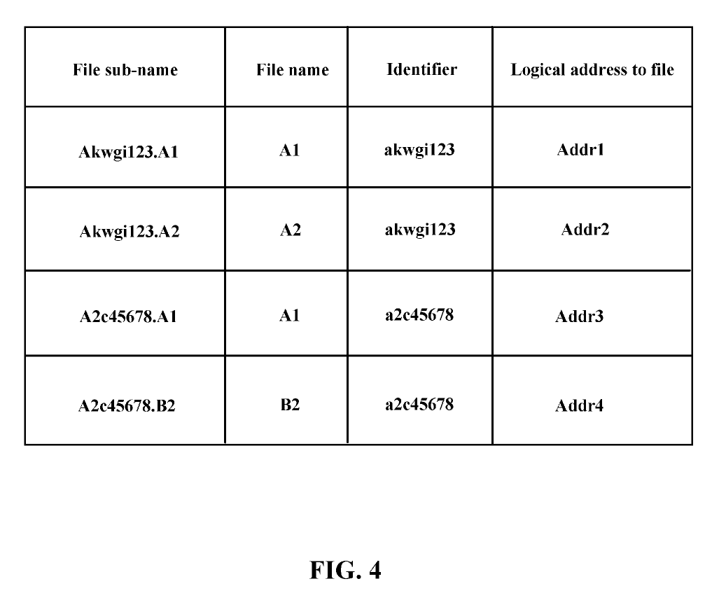

Referring to FIG. 4, the file information table includes file sub-names, file names, identifiers, and logical addresses to the files. As mentioned above, there are four files stored in the USB flash drives 73 and 75. Regarding the file A1 of the USB flash drive 73, its file sub-name is Akwgi123.A1, file name is A1, identifier is akwgi123, and logical address is Addr1. Regarding the file A2 of the USB flash drive 73, its file sub-name is Akwgi123.A2, file name is A2, identifier is akwgi123, and logical address is Addr2. Regarding the file A1 of the USB flash drive 75, its file sub-name is A2c45678.A1, file name is A1, identifier is a2c45678, and logical address is Addr3. Regarding the file B2 of the USB flash drive 75, its file sub-name is A2c45678.B2, file name is B2, identifier is a2c45678, and logical address is Addr4.

In writing operation, the computer 2 sends the write command and a size of the to-be-written data to the multiple adapter 4. The controller 41 sends a command to the comparer 43 to compare the capacity of the to-be-written data with the total spare capacity of the USB flash drives 73 and 75 stored in the memory 42. If the capacity of the to-be-written data is larger than the total spare capacity, the comparer 43 notifies the computer 2 that the total spare capacity of the USB flash drives 73 and 75 is not enough to store the to-be-written data. If the capacity of the to-be-written data is smaller than the total spare capacity, the comparer 3 sends a write command to the controller 41. The controller 41 controls the file manager 45 to write the to-be-written data to the USB flash drives 73 and 75 sequentially.

After completing the write operation, the controller 41 controls the detector 44 to detect the newly store information of the USB flash drives 73 and 75, and to send the newest store information to the file manager 45. The file manager 45 updates the file management table and the file information table.

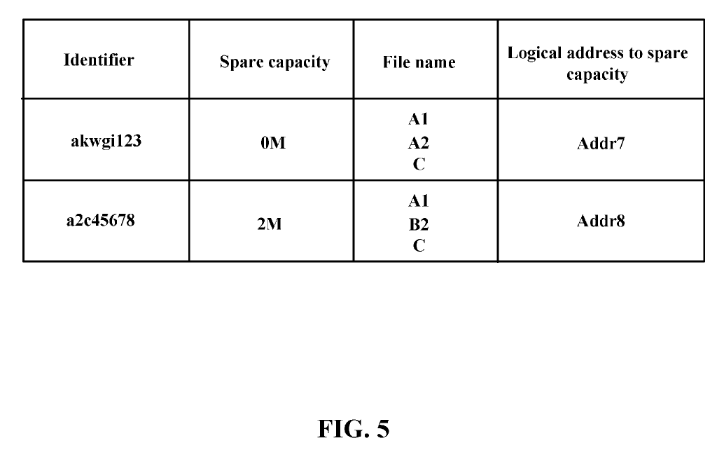

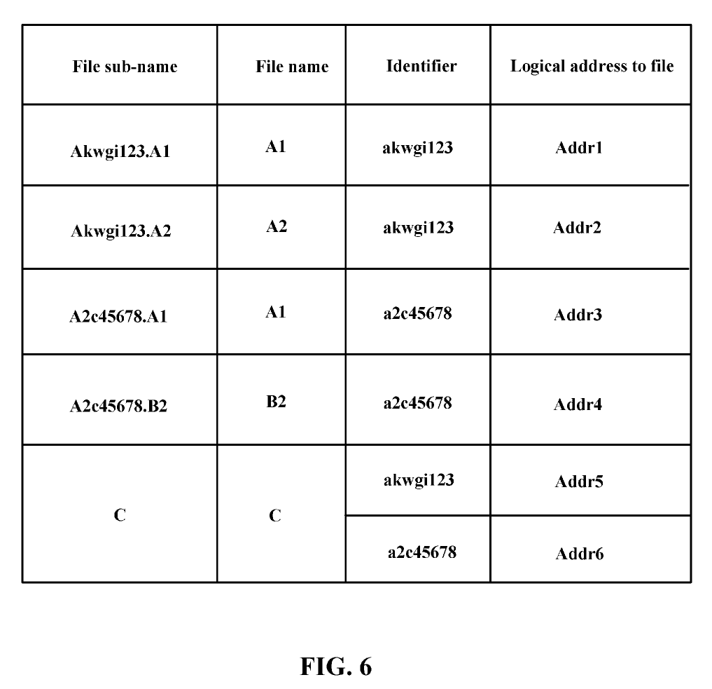

For example, referring to FIGS. 5 and 6, to-be-written data of a file C has been written into the USB flash drives 73 and 75 and the file management table and the file information table has been updated. In the updated file management table, the spare capacity of the USB flash drive 73 is reduced to 0 M, and the spare capacity of the USB flash drive 75 is reduced to 2 M. Moreover, the logical address of the USB flash drive 73 is changed to Addr7, and the logical address of the USB flash drive 75 is changed to Addr8. In the updated file information table, a logical address of a first part of the file C stored in the USB flash drive 73 is Addr5, and a logical address of a second part of the file C stored in the USB flash drive 75 is Addr6.

Take the aforementioned for example to explain a reading operation, the computer 2 sends the read command to the multiple adapter 4 to read the file C. The controller 41 controls the file manager 45 to read the file C from the USB flash drives 73 and 75 in turn according to the logical addresses Addr5 and Addr6.

Therefore, the multiple adapter 4 can help the computer 2 to substantially utilize the USB flash drives 73 and 75 to do the writing and reading operation.

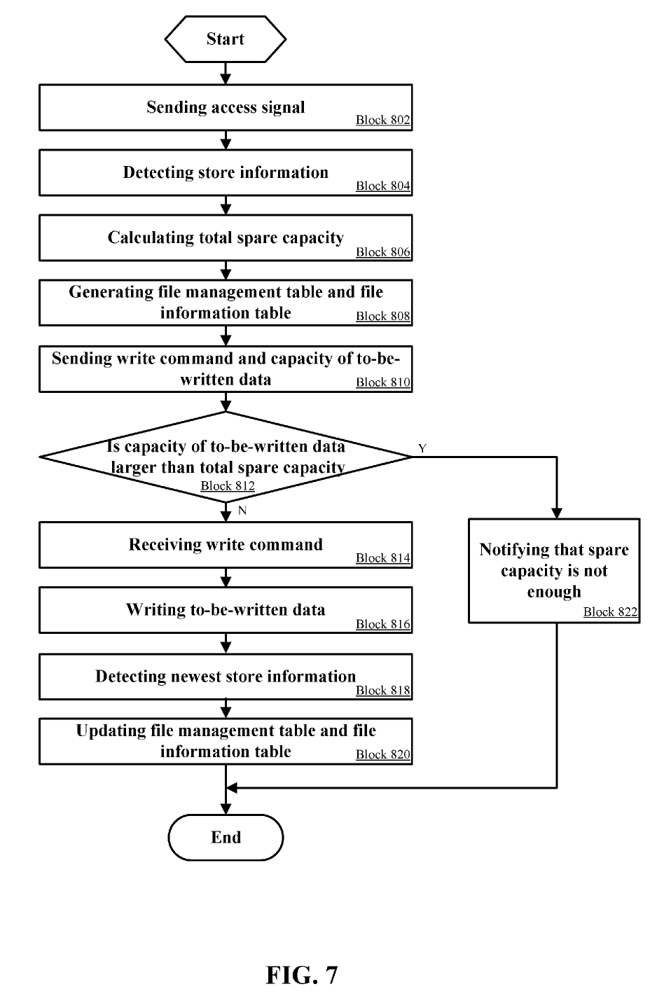

Referring to FIG. 7, a writing procedure of an access method in accordance with an exemplary embodiment is used for writing to-be-written data to a plurality of USB flash drives 70. The writing procedure includes the following blocks.

Block 802, the access signal is sent to the controller 41.

Block 804, the store information of the USB flash drives 70 is detected by the detector 44.

Block 806, the total spare capacity of the USB flash drives 70 is calculated by the file manager 45 based on the store information.

Block 808, the file management table and the file information table are generated by the file manager 45 based on the store information.

Block 810, the write command and the capacity of the to-be-written data are sent to the multiple adapter 4.

Block 812, the capacity of the to-be-written data is compared with the total spare capacity of the USB flash drives. If the capacity of the to-be-written data is larger than the total spare capacity, the procedure goes to block 822. If the capacity of the to-be-written data is smaller than the total spare capacity, the procedure goes to block 814.

Block 814, the write command is received by the controller 41.

Block 816, the to-be-written data is written into the USB flash drives 70 in turn by the file manager 45.

Block 818, the newest store information is detected by the detector 44.

Block 820, the file management table and the file information table are updated by the file manager 45.

Block 822, the computer 2 is notified that the total spare capacity is not enough to store the to-be-written data.

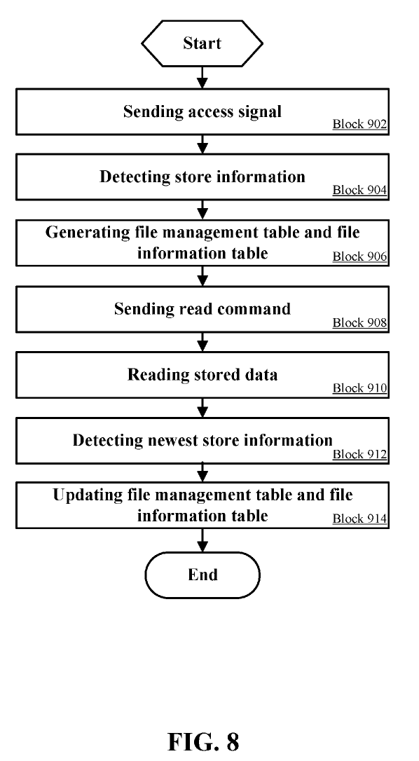

Referring to FIG. 8, a reading procedure of an access method in accordance with an exemplary embodiment is used for reading stored data from a plurality of USB flash drives 70. The reading procedure includes the following blocks.

Block 902, the access signal is sent to the controller 41.

Block 904, the store information of the USB flash drives 70 is detected by the detector 44.

Block 906, the file management table and the file information table are generated by the file manager 45 based on the store information.

Block 908, the read command is sent to the multiple adapter 4.

Block 910, the stored data is read from the USB flash drives 70 in turn according to the read command.

Block 912, the newest store information is detected by the detector 44.

Block 914, the file management table and the file information table are updated by the file manager 45.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A multiple adapter for assembling a plurality of flash drives, the multiple adapter comprising:
a multiple expansion port for being coupled to the flash drives;
a detector coupled to the multiple expansion port for detecting store information of the flash drives;
a file manager coupled to the multiple expansion port and the detector for receiving the store information, calculating total memory capacity and total spare capacity of the flash drives; and
a controller for controlling the detector and the file manager.

2. The multiple adapter according to claim 1, further comprising:
a memory for storing the total memory capacity and the total spare capacity and being controlled by the controller.

3. The multiple adapter according to claim 2, further comprising:
a connector for receiving information and being coupled to the controller.

4. The multiple adapter according to claim 3, further comprising:
a comparer for comparing a capacity of the information with the total spare capacity and being controlled by the controller.

5. The multiple adapter according to claim 1, wherein the file manager is used for generating a file management table and a file information table according to the store information of the flash drives.

6. The multiple adapter according to claim 5, wherein the file management table comprises identifiers of the flash drives, spare capacities of the flash drives, file names of files stored in the flash drives, and logical addresses to the spare capacities.

7. The multiple adapter according to claim 6, wherein the file information table comprises file sub-names, the file names, the identifiers, and logical addresses to the files.

8. A writing procedure of an access method for writing to-be-written data to a plurality of flash drives using a multiple adapter, the writing procedure comprising:
detecting store information of the flash drives;
calculating total spare capacity of the flash drives;
comparing a capacity of the to-be-written data with the total spare capacity;
sending a write command to the multiple adapter if the capacity of the to-be-written data is smaller than the total spare capacity; and
writing the to-be-written data to the flash drives in turn.

9. The writing procedure according to claim 8, further comprising:
sending an access signal to the multiple device.

10. The writing procedure according to claim 9, further comprising:
generating file management table and file information table.

11. The writing procedure according to claim 10, further comprising:
detecting newest store information of the flash drives;
updating the file management table and the file information table according to the newest store information.

12. The writing procedure according to claim 8, further comprising:
notifying that the total spare capacity is not enough to store the to-be-written data.

13. A reading procedure of an access method for reading stored data from a plurality of flash drives using a multiple adapter, the reading procedure comprising:
detecting store information of the flash drives;
generating a file management table and a file information table based on the store information;
sending a read command to the multiple adapter; and
reading the stored data from the flash drives in turn.

14. The reading procedure according to claim 13, further comprising:
sending an access signal to the multiple adapter.

15. The reading procedure according to claim 13, further comprising:
detecting newest store information of the flash device;
updating the file management table and the file information table according to the newest store information.
